(19) United States
(12) Patent Application Publication
(10) Pub. No.: US 2006/0192036 A1
(43) Pub. Date: Aug. 31, 2006

(54) Fuel injector including a multifaceted dimple for an orifice disc with a reduced footprint of the multifaceted dimple

(76) Inventor: J. Michael Joseph, Newport News, VA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/066,232

(22) Filed: Feb. 25, 2005

(51) Int. Cl. B05B 1/00; F02M 63/00

(52) U.S. Cl. 239/596; 239/533.2

(57) ABSTRACT

A fuel injector includes an orifice disc. The orifice disc includes an outer portion, a central portion, and an orifice. The outer portion is with respect to a longitudinal axis and extends parallel to a generally planar base surface. The outer portion bounds the central portion. The central portion includes a facet that extends parallel to a plane that is oblique with respect to the generally planar base surface. The orifice penetrates the facet and extends along an orifice axis that is oblique with respect to the plane. As such, the orientation of the orifice with respect to the longitudinal axis is defined by a combination of (1) a first relationship of the plane with respect to the generally planar base surface, and (2) a second relationship of the orifice axis with respect to the plane. A method of forming a multi-facetted dimple for the orifice disc is also described.

### FIELD OF INVENTION

This invention relates generally to electrically operated fuel injectors of the type that inject volatile liquid fuel into an automotive vehicle internal combustion engine, and in particular the invention relates to a novel thin disc orifice member for such a fuel injector.

### BACKGROUND OF THE INVENTION

It is believed that contemporary fuel injectors must be designed to accommodate a particular engine, not vice versa. The ability to meet stringent tailpipe emission standards for mass-produced automotive vehicles is at least in part attributable to the ability to assure consistency in both shaping and aiming the injection spray or stream, e.g., toward an intake valve(s) or into a combustion cylinder. Wall wetting should be avoided.

Because of the large number of different engine models that use multi-point fuel injectors, a large number of unique injectors are needed to provide the desired shaping and aiming of the injection spray or stream for each cylinder of an engine. To accommodate these demands, fuel injectors have heretofore been designed to produce straight streams, bent streams, split streams, and split/bent streams. In fuel injectors utilizing thin disc orifice members, such injection patterns can be created solely by the specific design of the thin disc orifice member. This capability offers the opportunity for meaningful manufacturing economies since other components of the fuel injector are not necessarily required to have a unique design for a particular application, i.e., many other components can be of a common design.

Another concern in contemporary fuel injector design is minimizing the so-called “sac volume.” As it is used in this disclosure, sac volume is defined as a volume downstream of a needle/seat sealing perimeter and upstream of the orifice hole(s). The practical limit of dimpling a geometric shaped into an orifice disc pre-conditioned with straight orifice holes is the depth or altitude of the geometric shape required to obtain the desired spray angle(s). In attaining larger bend and split spray angles, such requirements cause greater difficulty in the manufacturing and tend to increase the sac volume. At the same time, as the depth or height of the geometry increases, the amount of individual hole and dimple distortion also increases. In extreme instances, the disc material may shear between holes or at creases in the geometrical dimple.

It is believed that known orifice disc can be formed in the following manner. A flat metering disc is initially formed with an orifice that extends generally perpendicular to the flat orifice disc, i.e., a “perpendicular” orifice. In order to achieve a bending or split angle, i.e., an angle at which the orifice is oriented relative to a longitudinal axis of the fuel injector, the region about the orifice is dimpled such that the flat orifice disc is no longer generally planar in its entirety but is now provided with a multi-facetted dimple. As the orifice disc is dimpled, the material of the orifice disc is forced to yield plastically to form the multi-facetted dimple. The multi-facetted dimple includes at least two sides extending at a splitting angle x, i.e., the angle at which the planar surface of the facet on which the orifice is disposed thereon is oriented relative to the originally flat surface towards an apex. Since the orifice is located on one of the sides, the orifice is also oriented at a bending angle δ. Because the orifice originally extends perpendicularly through the flat surface of the disc, i.e., a “base” plane, the bending angle δ and the splitting angle λ, in combination, define a resulting spray direction. And depending on the physical properties of the material such as, for example, thickness and yield strength of the material, it is believed that there is an upper limit to the dimpling angle, as too great a dimpling angle can cause the material to shear, rendering the orifice disc structurally unsuitable for its intended purpose.

### SUMMARY OF THE INVENTION

The present invention relates to novel forms of thin disc orifice members that can enhance the ability to meet different and/or more stringent demands with equivalent or even improved consistency. For example, certain thin disc orifice members according to the invention are well suited for engines in which a single fuel injector is required to direct sprays or stream to one or more intake valve; and thin disc orifice members according to the invention can satisfy difficult installations where space for mounting the fuel injector is severely restricted due to packaging constraints. It is believed that one of the advantages of the invention arises because the metering orifices are located in facetted planar surfaces. This has been found important in providing enhanced flow stability for proper interaction with upstream flow geometries internal to the fuel injector. The presence of a metering orifice in a non-planar surface, such as in a conical dimple, may not be able to consistently achieve the degree of enhanced flow stability that is achieved by its disposition on a facetted planar surface as in the present invention. The particular shape for the indentation that contains the facetted planar surfaces having the metering orifices further characterizes the present invention.

The preferred embodiments of the present invention allow for a desired targeting of fuel spray. The desired targeting of fuel spray is one that is similar to a fuel spray targeting generated by a control case. By virtue of the preferred embodiments, however, a desired spray targeting similar to the spray targeting of the control case can be obtained while providing for a fuel injector that has less sac volume and less material deformation in an orifice disc than that of the control case. Consequently, it is believed that the present invention provides a better control of fuel flow and spray angles by virtue of reduced orifice hole distortion resulting in better control variability.

The present invention provides a fuel injector for spray targeting fuel. The fuel injector includes a seat, a movable member, an orifice disc, and at least one metering orifice. The seat includes a passage extending along a longitudinal axis between a sealing surface and an outlet surface. The closure member is disposed in the passageway and contiguous to the sealing surface so as to generally preclude fuel flow through the seat orifice in one position. The closure member being coupled to a magnetic actuator that, when energized, positions the closure member away from the sealing surface of the seat so as to allow fuel flow through the passageway and past the closure member. The orifice disc is contiguous to the outlet surface of the seat, the orifice disc has an outer perimeter that defines a first surface area. The orifice disc includes first and second surfaces, the first surface confronting the seat, and the second surface facing opposite the first surface; an outer portion extending parallel to a generally planar base surface, and the generally planar base surface being generally orthogonal with respect to the longitudinal axis; a central portion being bounded by the outer portion and including at least first and second planar facets intersecting the outer portion to define a polygon on the outer portion, the at least first and second planar facet intersecting each other to define a segment extending at a first angle with respect to the generally planar base surface, each of the first and second planar facet extending at a second angle with respect to the generally planar base surface. The at least one orifice penetrates each of the first and second planar facets and being defined by a first wall coupling the first and second surfaces. The at least one orifice extends along a first orifice axis, and the first orifice axis is oblique with respect to the planar facet surface by a combination of a first relationship of the planar facet surface with respect to the generally planar base surface and a second relationship of the first orifice axis with respect to the planar facet surface so that the polygon is circumscribed by a virtual circle having a second surface area of less than 40% of the first surface area.

The present invention further provides a method of manufacturing a fuel injector. The fuel injector has a passageway extending between an inlet and outlet along the longitudinal axis. The fuel injector includes a seat proximate the outlet, a metering disc having a perimeter generally perpendicular to the longitudinal axis, and a closure member disposed in the passageway and coupled to a magnetic actuator. The method can be achieved by locating a plurality of metering orifices on at least two planar surfaces projecting from the metering disc within a circle contiguous to at least two points on the perimeter of the two planar surfaces; and minimizing a radius circumscribing the planar surfaces to no greater than a maximum radius of a hermetic weld with respect to the longitudinal axis.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention.

FIG. 1 is a cross-sectional view of a fuel injector according to a preferred embodiment of the present invention.

FIG. 1A is a cross-sectional view of a modular fuel injector according to another preferred embodiment.

FIG. 1B is a close-up cross-sectional view of the outlet end portion for the fuel injector of FIGS. 1 or 1A.

FIG. 1C is a perspective view of a multi-faceted dimpled orifice disc according to a preferred embodiment.

FIG. 2 is fragmentary cross-sectional view of an orifice disc according to a preferred embodiment of the present invention in an intermediate condition with the top view of this section being illustrated in FIGS. 5A and 5B.

FIG. 3 is a fragmentary cross-sectional view of the orifice disc according to the preferred embodiment of the present invention, as shown in FIGS. 1C, 6, 7, and 8 in a final condition.

FIGS. 4A and 4B illustrate the dimensions of an orifice disc in an initial pre-dimpled configuration to a final dimpled configuration for a control case in comparative analysis that achieves a predetermined spray targeting.

FIGS. 4C and 4D illustrate other dimensions of the thin disc of FIG. 4B.

FIGS. 5A and 5B illustrate an orifice disc, prior to dimpling, that can be used for the preferred embodiments.

FIG. 6 illustrates a comparison between a configuration of a first preferred embodiment of an orifice disc relative to the control case that achieves the same exemplary spray results.

FIG. 7 illustrates a comparison between a configuration of a second preferred embodiment of an orifice disc relative to the control case that achieves the same exemplary spray results.

FIG. 8 illustrates a comparison between a configuration of a third preferred embodiment of an orifice disc relative to the control case that achieves the same exemplary spray results.

### DETAILED DESCRIPTION OF THE PREFERRED EMBODIMENT(S)

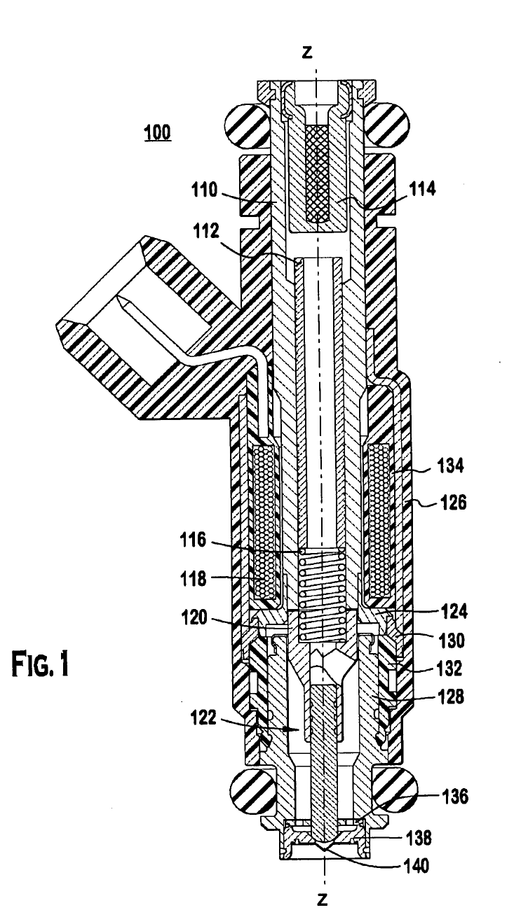

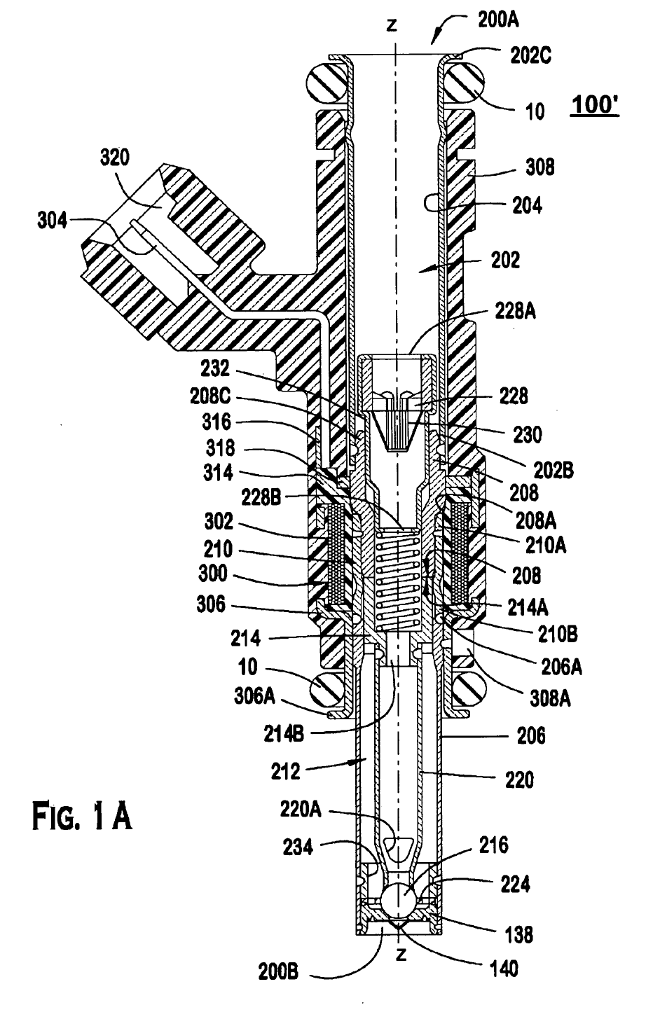

FIGS. 1-3 and 5-8 illustrate the preferred embodiments. In particular, FIG. 1 illustrates a fuel injector 100 that includes: a fuel inlet tube 110, an adjustment tube 112, a filter assembly 114, a coil assembly 118, a coil spring 116, an armature 120, a closure member assembly 122, a non-magnetic shell 124, a fuel injector overmold 126, a body 128, a body shell 130, a shell overmold 132, a coil overmold 134, a guide member 136 for the closure member assembly 122, a seat 138, and a metering disc 140. The components of the fuel injector 100 are assembled together into a single operable assembly, in order for the fuel injector to meter fuel.

The construction of the fuel injector of FIGS. 1 and 1A can be of a type similar to those disclosed in commonly assigned U.S. Pat. Nos. 4,854,024; 5,174,505; and 6,520,421, which are incorporated by reference in their entireties into this application.

FIG. 1B shows the outlet end of a body 128 of a solenoid operated fuel injector 100 having an orifice disc 140 according to a preferred embodiment. The outlet end of fuel injector 100 includes a guide member 136 and a seat 138, which are disposed axially interiorly of orifice. disc 140. The seat 138 has a seat orifice portion 138 A. The seat orifice portion 138 A connects the sealing surface 138C and planar surface 138E, which define a portion of a flow passage of the seat. The guide member 136 includes a central opening 136A with guide orifices 136B surrounding the central opening 136A. The guide member 136, seat 138 and disc 140 can be retained by a suitable technique such as, for example, forming a retaining lip with a retainer or by welding the disc 140 to the seat 138 with weld 138F, and welding the seat 138 to the body 128 with a weld 138G that extends through the body to the seat 138.

Seat 138 can include a frustoconical seating surface 138E that leads from guide member 136 to the orifice portion 138A of the seat 138 that, in turn, leads to a dimpled central portion 140 a of orifice disc 140. Guide member 136 includes a central guide opening 136a for guiding the axial reciprocation of a sealing end 122a of a closure member assembly 122 and several through-openings 136b distributed around opening 136a to provide for fuel to flow into the fuel sac volume discussed earlier. The fuel sac volume is the encased volume downstream of the needle sealing seat perimeter, which is the interface of 122a and 138E, and upstream of the metering orifices in the area 140a. FIG. 1B shows the hemispherical sealing end 122a of closure member assembly 122 seated on sealing surface 138E, thus preventing fuel flow through the fuel injector in the closed position of the fuel injector. When the closure member 122 is moved away from the sealing surface 138E via an actuator, fuel is permitted to flow through orifices of the orifice disc 140.

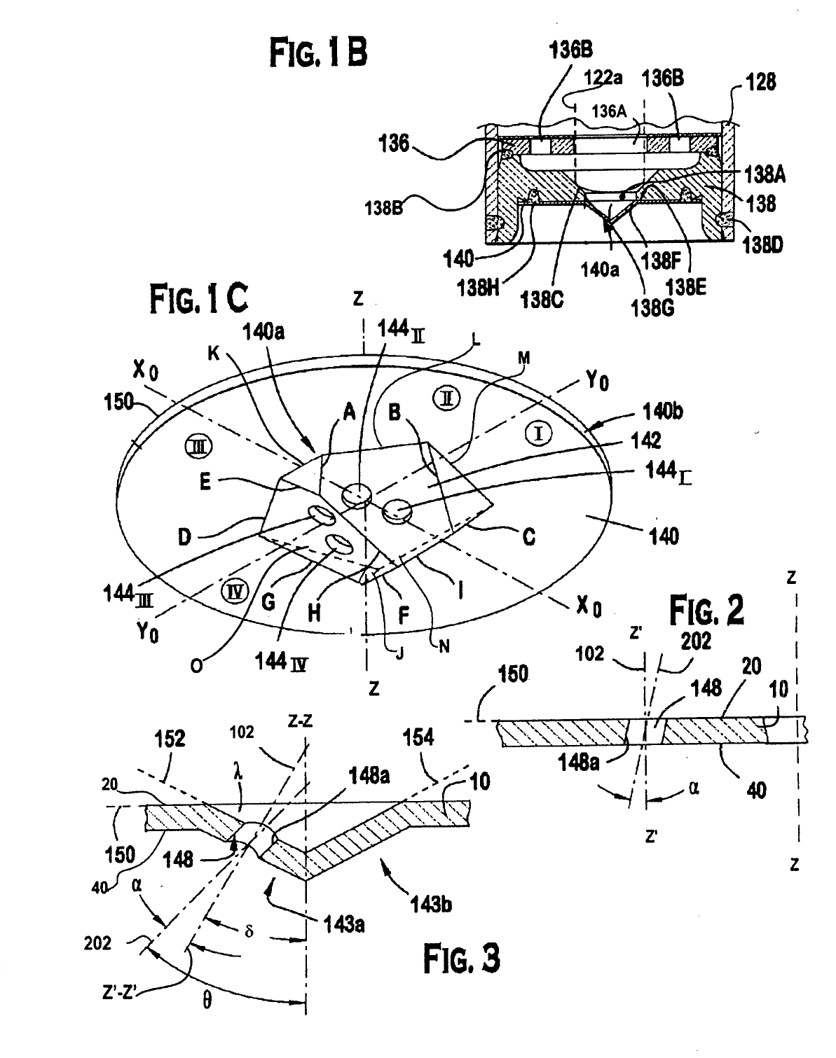

As shown in FIG. 1B, a volume is defined by the first surface of the orifice disc and the sealing end 122 a cooperating with the sealing surface 138A to prevent the flow of fuel. This volume is generally related to the orientation of the first orifice with respect to the longitudinal axis. That is, with reference to FIGS. 2 and 3, as the first orifice 148 is oriented at increasing angle δ relative to axis Z-Z, this volume, also known as the “sac” volume, increases. Conversely, as the first orifice 148 is oriented at decreasing angle δ relative to the axis Z-Z, the sac volume decreases.

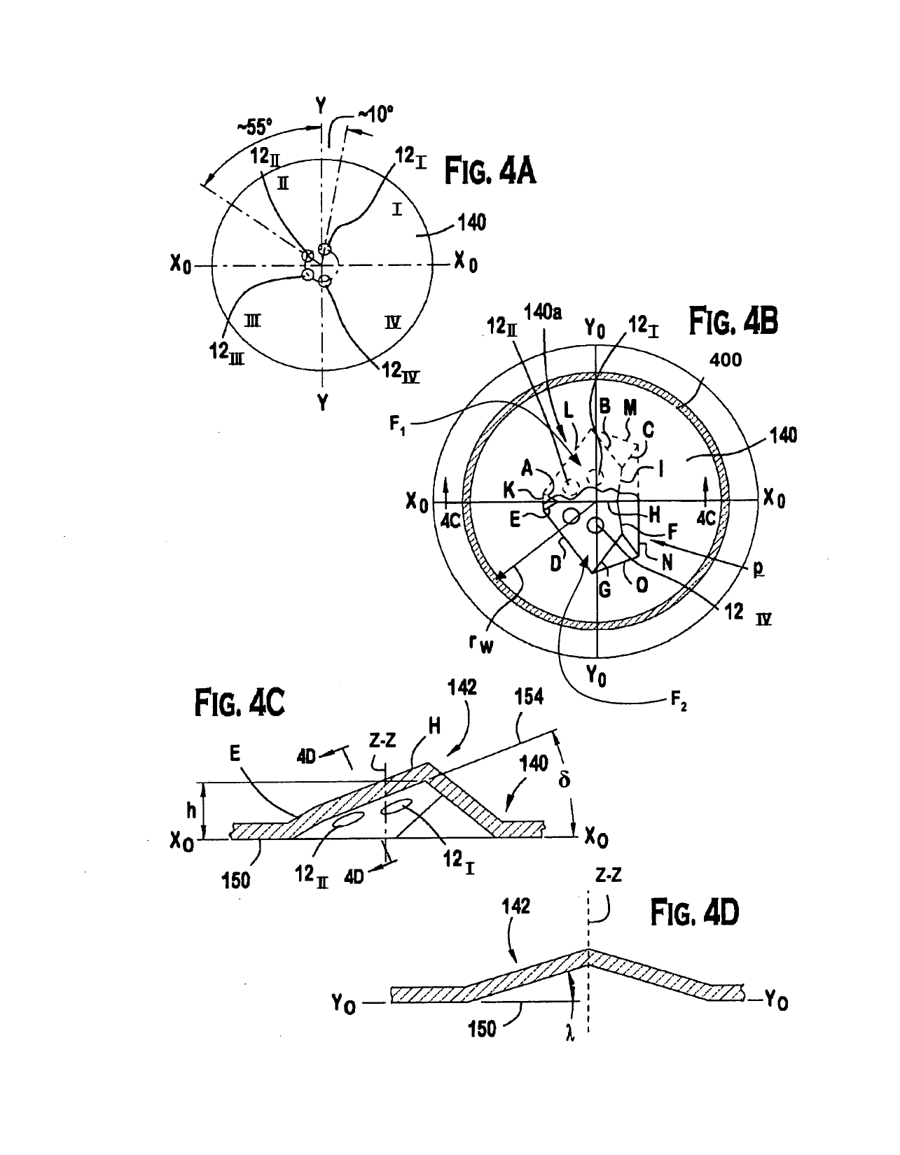

The orifice disc 140, as viewed from outside of the fuel injector in a perspective view of FIG. 1C, has a generally circular shape with a circular outer portion 140b that circumferentially bounds the central portion 140a and is disposed axially in the fuel injector. The orifice disc 140 can be attached to the seat outlet surface 138E by a suitable technique, such as, for example, welding, brazing, bonding or laser welding. Preferably, as shown in FIGS. 1B and 4B, the orifice disc 140 is attached to the seat by a weld 400 extending from the second surface 40 of the orifice disc 140 to the seat outlet surface 138E. Also preferably, the weld 138F or 400 circumscribes the longitudinal axis Z-Z so that a hermetic seal is formed between the seat outlet surface 138E and the first surface 20 by the weld 138F or 400, which preferably is continuous about the longitudinal axis.

With reference to FIGS. 2 and 3, the preferred embodiments achieve an increased bending angle, denoted here as bending angle θ (in the case of FIG. 3) or β (in the preferred embodiments of FIGS. 1, 1A-1C, and 4-8 ), without an increase in a splitting angle λ that must be applied to the workpiece. Briefly, the increased bending angle θ can be formed by initially forming an orifice that is angled to a flat workpiece 10 at an orifice angle α, i.e., “angled” orifice, relative to a virtual generally planar base surface 150 which is contiguous to at least a portion of disc. Thereafter, the workpiece 10 is deformed to form a multi-facetted dimple 143a at the same splitting angle λ as in the conventional dimpled disc. As shown in FIG. 3, however, the new bending angle θ is not related directly as a function of the splitting angle λ but is related as a function of two angles: (1) the orifice angle α and (2) the splitting angle λ Thus, the increased bending angle θ for spray targeting results from approximately the sum of the orifice angle α and the splitting angle λ. As used herein, the term “splitting angle λ” is the angle formed between adjacent facets (defined by A, H, I, B, and L and E, D, G, F, and H) along the forming axis H in FIG. 1C.

In the preferred embodiments, the central portion 140a of orifice disc 140 includes a multi-faceted dimple 142 that is bounded by the central portion 140a, as shown in FIG. 1C. The central portion 140a of orifice disc 140 is imperforate except for the presence of one or more orifices 144 via which fuel passes through orifice disc 140. Any number of orifices 144 in a suitable array about the longitudinal axis Z-Z can be configured so that the orifice disc 140 can be used for its intended purpose in metering, atomizing and targeting fuel spray of a fuel injector. The preferred embodiments include four such through-orifices 144_{I}, 144_{II}, 144_{III}, 144_{IV}, and it can be seen in FIG. 1C, that these orifices can be disposed solely on the planar surfaces of a multi-faceted dimple 142 of the orifice disc 140.

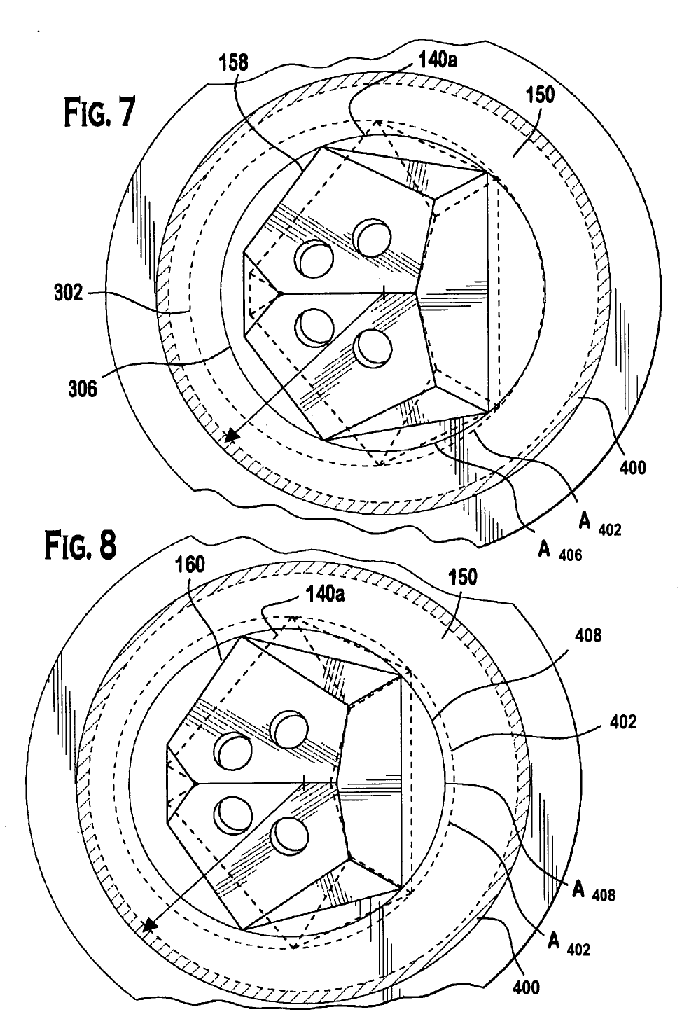

Referencing FIGS. 1C and 6, the multi-faceted dimple 142 of one preferred embodiment includes six generally planar surfaces oblique to a virtual generally planar base surface 150 extending between the peripheral and central portions of the orifice disc 140. The six generally planar surfaces intersect each other to form various face line or segments denoted as A, B, C, D, E, F, G, H, I, J, K, L, M, N, and O (FIG. 4B). The orifices can be located on any one of the facets as long as the facet includes sufficient area for the orifices to be disposed thereon. In the preferred embodiments, two orifices are located on a first planar facet F1 bounded by segments A, B, H, I, and L, and two other orifices are located on a second planar facet F2 bounded by segments D, E, F, G, and H. A third facet bounded by segments A, E, and K is contiguous to the first and second planar facets. A fourth facet bounded by segments J, F, C, I and N is also contiguous to the first and second planar facets. A fifth facet bounded by segments BMC and its mirror image sixth facet bounded by segments G, J, and O are contiguous to the fourth facet and to either the first or second planar facets, respectively. Although the third through sixth facets, in the preferred embodiments, are not provided with orifices penetrating through each of the third through sixth facets, these surfaces can be provided with one or more orifices in a suitable application, such as, for example, an intake port with three intake valves.

Referring to FIG. 4C, the intersection of the six facets with the generally planar base surface 150 forms a polygon P. The polygon P has its perimeter formed by segments D, O, N, M, L, K. The A foot print A₄₀₂ (FIG. 6) of the polygon P can be represented by circumscribing a circular area so that the circumference of the circular area is contiguous to each apex of the polygon. The polygon forming the dimpled surface can be of a suitable shape to permit desired targeting of fuel spray. Preferably, the polygon P is a hexagon-shaped polygon so that the circumscribed circular area is contiguous to respective intersections of each of the segments D, O, N, M, L, K with each other.

The preferred embodiments of the dimpled orifice disc 140 provide for an increase in a spray angle θ relative to a longitudinal axis Z-Z for each of the orifices without changing the facet geometry relative to the generally planar base surface 150. From another point of view, the preferred embodiments, including the description of the techniques disclosed herein, allow the orifice disc to maintain the same spray targeting and enhanced structural rigidity by reduction of significant polygon parameters such as the height of the apex of the dimple with respect to a generally planar base surface. Therefore, the preferred embodiments achieve the same performance and can be utilized with a smaller sac volume.

Prior to the formation of the first facet 142, the orifice disc 140 includes first and second surfaces 20, 40 that extend substantially parallel to a generally planar base surface 150. The first and second surfaces 20 and 40 are spaced along a longitudinal axis Z-Z. The longitudinal axis Z-Z extends orthogonally with respect to the generally planar base surface 150, as shown in FIGS. 1C, 3, and 4D. Preferably, the first and second surfaces 20, 40 are spaced apart over a distance of between 75 microns to 300 microns, inclusive of the values thereof.

The preferred embodiments of the orifice disc 140 can be formed by a method as follows. The method includes forming a first angled “α” orifice 148 penetrating the first and second surfaces 20, 40, respectively, and also forming a first planar surface or facet 143a on which the first orifice 148 is disposed thereon such that the first facet 143a extends generally parallel to a first plane 152 oblique to the generally planar base surface 150. The first orifice 148 is defined by a first wall 148a that couples the first and second surfaces, 20 and 40, respectively, and the first orifice 148 extends along a first orifice axis 102 oblique with respect to the axis Z′-Z′. Although the orifice can be formed of a suitable cross-sectional area such as for example, square, rectangular, oval or circular, the preferred embodiments include generally circular orifices having a diameter about 100 microns, and more particularly, about 125 microns. The first orifice 148 can be formed by a suitable technique or a combination of such techniques, such as, for example, laser machining, reaming, punching, drilling, shaving, or coining. Preferably, the first orifice 148 can be formed by stamping and punch forming such that when a dimpling tool deforms the workpiece 10, a plurality of planar surfaces oblique to a generally planar base surface 150 can be formed. One of the plurality of the planar surfaces can include first facet 143a.

Thereafter, a second facet 143b can be formed at the same time or within a short interval of time with the first facet 143a. The second facet 143b can be generally parallel to a second plane oblique 154 to the generally planar base surface 150 such that the orifices disposed on the second facet is oblique to the longitudinal axis Z-Z. The second facet 143b can also be oblique with respect to the first facet 143a. Additional facets can also be formed for the orifice disc in a similar manner to provide for a dimple with more than two facets.

In order to quantify the advantages of the preferred embodiments with respect to metering orifice plate that utilizes straight or non-angled orifices prior to the formation of facets (i.e., a control case), comparisons were made with respect to preferred embodiments that utilize angled orifices prior to the formation of facets. The control case was a workpiece that utilizes orifices extending perpendicular to the planar surfaces of the workpiece, which is deformed to form a plurality of facets. The metering disc of the control case was configured so that it provides a desired fuel spray-targeting pattern under controlled conditions. The test cases, on the other hand, utilize the preferred embodiments at various configurations such that these various configurations permit fuel spray targeting similar to the desired fuel spray targeting under the controlled conditions. That is, even though the physical geometry of each of the test cases was different, the fuel spray targeting of each of the test cases was required to be generally similar to that of the control case. And as used herein, spray targeting is defined as one of a bent spray angle or a split spray angle relative to the longitudinal axis of a standardized fluid flowing through the fuel injector of the control case and the preferred embodiments at controlled operating conditions, such as, for example, fuel temperature, fuel pressure, flow rate and coil actuation duration.

An orifice disc 140 using perpendicular orifices prior to dimpling, i.e., a “pre-dimpled” disc, for the control case is shown in FIG. 4A. The pre-dimpled disc 140 has four orifices 12_{I}, 12_{II}, 12_{III}, and 12_{IV} located about the geometric center of the orifice disc and arrayed such that each of the centers of the orifices are located within respective quadrants I, II, III, and IV for this particular example. Specifically, two of the orifices, denoted here as orifice 12_{I} and 12_{IV} are symmetrical about centerline X₀-X₀. Each of orifices 12_{I} and 12_{IV} is located at, respectively, approximately 10 degrees from centerline Y-Y. Orifices 12_{II} and 12_{III} are also symmetrical about centerline X₀-X₀ and each is located at approximately 55 degrees from the centerline Y₀-Y₀. Each of the orifices 12_{I}, 12_{II}, 12_{III}, and 12_{IV} extends generally perpendicular through disc 140 such that an axis of each of the orifices is generally parallel to the longitudinal axis Z-Z of the fuel injector prior to being dimpled; and, therefore the angle of deviation (i.e., orifice angle α) between the axis of each of the orifices 12_{I}, 12_{II}, 12_{III}, and 12_{IV} with the longitudinal axis is about zero degrees.

The orifice disc 140 after dimpling, i.e., a “post-dimpled” orifice disc is shown for the control case in FIG. 4B, as viewed from outside of the fuel injector, as a multi-facetted dimple 140a. Preferably, the multi-faceted dimple 140a includes six generally planar facets that are oblique to a generally planar base surface 150 extending through the outer portion of the orifice disc 140. The maximum height “h” of the apex of the dimple 142, bent spray angles δ, and split angle λ, shown here in FIGS. 4C and 4D, respectively, are measured for comparison purpose with the preferred embodiments. As used herein, the bent spray angle δ, as applied to a multifaceted dimple, denotes the angle of a dimpled surface with respect to the generally planar base surface 150 that tends to orient a flow of fuel through the metering orifices asymmetrically with respect to axis Yₒ-Yₒ and towards two or more sectors. As also used herein, the split angle λ denotes the angle of a dimpled surface with respect to the generally planar base surface 150 that tends to orient a flow of fuel through the metering orifices symmetrically with respect to axis Xₒ-Xₒ (FIG. 4D). The magnitudes of the parameters defining the multi-faceted dimple 142 are collated in the row labeled as “CONTROL” in Table I below.

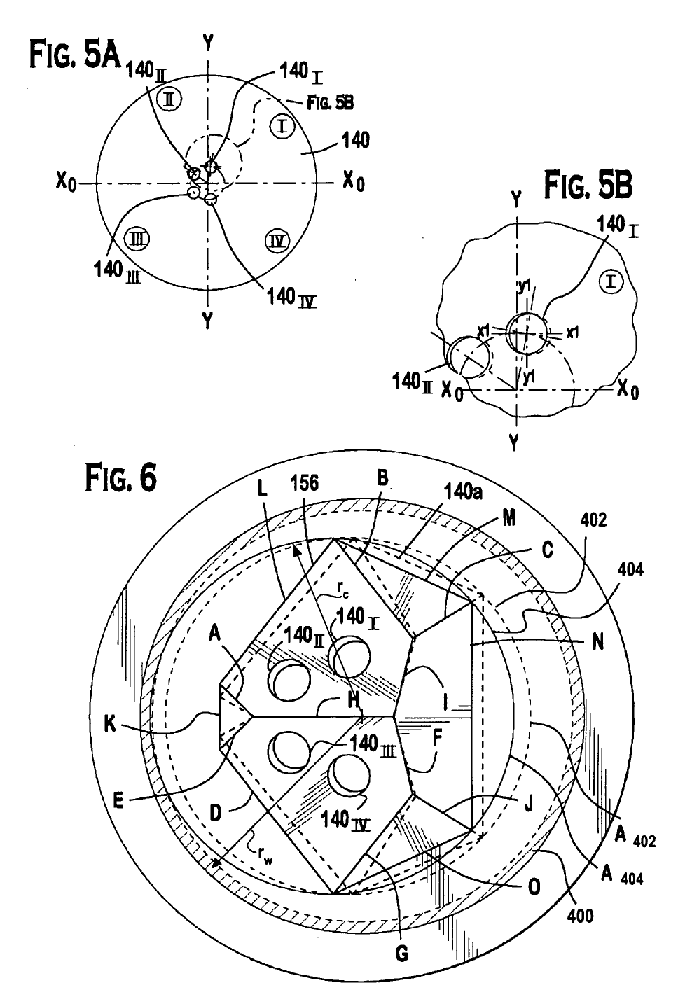

FIG. 5A illustrates a “pre-dimpled” orifice disc 140 that can be used for the preferred embodiments. Reference is made with the close-up view of FIG. 5B, which shows two of the four orifices as angled orifices extending through the orifice disc at orifice angle α (FIG. 2) of about six degrees with respect to the longitudinal axis Z-Z. The disc 140 is deformed to form a multi-faceted dimple 156, as shown in solid lines in FIG. 6.

FIG. 6 provides a pictorial comparison of a “post-dimpled” first preferred embodiment (facets depicted as solid lines) 156 with the multi-facetted dimple 140a of the control case (facets depicted as dashed lines). The preferred embodiment of FIG. 6 uses orifices, in the pre-dimpled orifice disc, with an orifice angle α of six degrees ( 6°) as measured to the perpendicular axis Z-Z or its complementary angle of eighty-four degrees ( 84°) as measured to the generally planar base surface 150. It should be noted that the particular configuration of the multi-faceted dimple 156 of FIG. 6 allows the orifice disc 140 to obtain approximately the same spray targeting as the control case. Further, it can be seen in the row labeled “Disc 1” of Table I that significant parameters defining the geometry of various facets of the first preferred embodiment as compared to the control case are much smaller in magnitude (as signified by bold notations for each of the parameters in Table I) for the same spray targeting as the control case. The decreases in these significant parameters are believed to be advantageous. The four significant parameters include: the height “h” of apex H; sac volume, bending spray angle β and split angle λ. For example, the sac volume is reduced by approximately 11%; the bending spray angle β by 16%; the split angle λ by approximately 20%.

FIG. 7 illustrates a second preferred embodiment of a multi-facet dimple 158 (depicted as solid lines) in comparison with the dimple 140a of the control case (designated as dashed lines). The preferred embodiment of FIG. 7 uses orifices, in the pre-dimpled orifice disc, with an orifice angle a of eight degrees (8°) as measured to the axis Z-Z of the pre-dimpled orifice disc or its complementary angle of eighty-two degrees (82°) as measured to the generally planar base surface 150.

FIG. 8 illustrates a third preferred embodiment (depicted as solid lines) of a multi-facetted dimple 160 in comparison with the dimple 140a of the control case (designated as dashed lines). The preferred embodiment of FIG. 8 uses orifices, in the pre-dimpled orifice disc, with an orifice angle α of ten degrees (10°) as measured with respect to the longitudinal axis Z-Z or its complementary angle of eighty degrees (80°) as measured to the generally planar base surface 150. It should be noted that the particular configuration of the multi-faceted dimple 160 of FIG. 8 allows the orifice disc 140 of FIG. 8 to obtain approximately the same spray targeting as the control case.

Of particular note in the preferred embodiments shown by FIGS. 6-8 is the reduction in the area of a footprint relative to the control case, denoted as A402, of the dimpled area as the orifice angle α is increased in FIGS. 6-8. It is believed that, in order to maintain a desired structural integrity, the weld 400 is preferably further away from dimple 142 (FIG. 1C). In other words, the main objective is to locate the facets as far away from the weld beads 400. The size of the footprint of the multi-faceted dimple therefore is believed to be important to the manufacturing of the fuel injector. That is, depending on where the weld 400 is formed in relation to the dimple 142, it is believed that the heat generated by the weld 400 can affect a desired structural integrity (e.g., heat related distortion) of the orifice disc or the multi-faceted dimple 142. Preferably, where the orifice disc 140 is of a circular configuration, the dimple 142 can be located on a circumscribed circle (i.e., one that is contiguous to at least two points of the polygon defined by the dimple 142) having a maximum radius r_{c} no greater than the minimum radius r_{w} of the hermetic weld bead A₄₀₀ (FIG. 6) and preferably a maximum radius for a circumscribed area A406 smaller than area A₄₀₂ (FIG. 7), or a circumscribed area A₄₀₈ even smaller than circumscribed area A₄₀₆ (FIG. 8).

The comparative analysis above is believed to illustrate the advantages of the present invention in allowing for at least a reduced sac volume, apex height “h”, bending spray angle β and split angle λ while maintaining the same spray targeting of a control case that uses perpendicular orifices in the pre-dimpled orifice disc. Furthermore, by comparisons with a control case, it can be seen that the preferred embodiments permit generally the same desired fuel spray targeting previously achievable with a control case yet with better fuel injector characteristics such as, for example, sac volume, lower material distortion or failure of the metering disc during the manufacturing process. It can be seen that the spray angle θ of each of the orifices is now a result of at least two angles (orifice angle α and at least one of the bending spray angle β and split angle λ) such that extreme cases of orifice geometry can be manufactured without causing any reduction in structural integrity of the orifice disc 140 while also reducing the sac volume, the height of the apex and the amount of dimpling force or stress applied to the orifice disc without impairing the strength or integrity of the metering disc. Moreover, by virtue of the preferred embodiments, a footprint of a dimpled surface can be sufficiently spaced from a weld bead so that structural integrity of the disc can be maintained during manufacturing or assembly of the fuel injector.

While the present invention has been disclosed with reference to certain preferred embodiments, numerous modifications, alterations, and changes to the described embodiments are possible without departing from the sphere and scope of the present invention, as defined in the appended claims. Accordingly, it is intended that the present invention not be limited to the described embodiments, but that it have the full scope defined by the language of the following claims, and equivalents thereof.

TABLE I
Data of Control Case, First, Second, and Third Preferred Embodiments

| | | | IV | | | VII | VIII | IX |
|---|---|---|---|---|---|---|---|---|
| | | III | Height “h” | V | VI | Ratio of Area | Area of | Percent |
| | II | Sac | of Apex of | Bending | Split | of Weld to | Foot | Change in |
| I | Orifice | Volume | Facet “H” | Angle | Angle λ | Area of | Print | Area of |
| Configuration | angle α | (mm)³ | (mm) | β (degrees) | (degrees) | Footprint | (mm²) | Foot Print |
| CONTROL | 0° | 0.812 | 0.56 | 21° | 16° | 1.8 | 7.1 | — |
| DISC 1 | 6° | 0.726 | 0.491 | 17.7° | 12.8° | 1.81 | 6.9 | −2% |
| DISC 2 | 8° | 0.768 | 0.490 | 17.0° | 11.5° | 1.87 | 6.7 | −5% |
| DISC 3 | 10° | 0.696 | 0.467 | 16.4° | 10.2° | 2.32 | 5.9 | −16% |

What i claim is:

1. A fuel injector for metering and spray targeting fuel, the fuel injector comprising:
a seat including a passage extending along a longitudinal axis between a sealing surface and an outlet surface;
a closure member disposed in the passageway and contiguous to the sealing surface so as to generally preclude fuel flow through the seat orifice in one position, the closure member being coupled to a magnetic actuator that, when energized, positions the closure member away from the sealing surface of the seat so as to allow fuel flow through the passageway and past the closure member;
an orifice disc contiguous to the outlet surface of the seat, the orifice disc having an outer perimeter defining a first surface area, the orifice disc including:
first and second surfaces, the first surface confronting the seat, and the second surface facing opposite the first surface;
an outer portion extending parallel to a generally planar base surface, and the generally planar base surface being generally orthogonal with respect to the longitudinal axis;
a central portion being bounded by the outer portion and including at least first and second planar facets intersecting the outer portion to define a polygon on the outer portion, the at least first and second planar facet intersecting each other to define a segment extending at a first angle with respect to the generally planar base surface, each of the first and second planar facet extending at a second angle with respect to the generally planar base surface; and
at least one orifice penetrating each of the first and second planar facets and being defined by a first wall coupling the first and second surfaces, the at least one orifice extending along a first orifice axis, and the first orifice axis being oblique with respect to the planar facet surface by a combination of a first relationship of the planar facet surface with respect to the generally planar base surface and a second relationship of the first orifice axis with respect to the planar facet surface so that the polygon is circumscribed by a virtual circle having a second surface area of less than 40% of the first surface area.

2. The fuel injector according to claim 1, wherein the first angle comprises a bending angle of less than 21 degrees and the second angle comprises a splitting angle of less than 16 degrees.

3. The fuel injector according to claim 2, wherein the bent angle is selected from a group consisting one of approximately 17.7 degrees, 17.0 degrees and 16.4 degrees.

4. The fuel injector according to claim 3, wherein the split angle is selected from a group consisting one of approximately 12.8 degrees, 11.5 degrees and 10.2 degrees.

5. The fuel injector according to claim 4, wherein the at least one orifice comprises first through fourth orifices symmetrical about a first axis extending transverse to the longitudinal axis, the first and fourth orifices being oriented at approximately 10 degrees with respect to a second axis extending transversely to the first axis and the second and third orifices being oriented at approximately 55 degrees with respect to the second axis.

6. The fuel injector according to claim 5, wherein each of the at least one orifice has a diameter ranging from 0.1 millimeters to 0.6 millimeters.

7. The fuel injector according to claim 6, wherein the wall of each of the first through fourth orifices extends at an orifice angle selected from a group consisting of approximately 6 degrees, 8 degrees and 10 degrees.

8. The fuel injector according to claim 7, wherein the metering disc cooperates with the closure member and seat to form a sac volume of less than approximately 0.8 cubic-millimeters.

9. The fuel injector according to claim 8, wherein orifice disc is affixed to the outlet surface by at least one weld between the outlet surface and the first generally planar surface of the orifice disc so that the weld is located at a first radius about the longitudinal axis to define a third surface area.

10. The fuel injector of claim 9, wherein the second surface area comprises about 67% of the third surface area.

11. A method of manufacturing a fuel injector, the fuel injector extending between an inlet and an outlet along a longitudinal axis, the fuel injector having a seat connected to a metering orifice disc proximate the outlet, the method comprising:
locating a plurality of metering orifices on at least two planar surfaces projecting from the metering disc within a circle contiguous to at least two points on the perimeter of the two planar surfaces; and
minimizing a radius circumscribing the planar surfaces to no greater than a maximum radius of a hermetic weld with respect to the longitudinal axis.

12. The method according to claim 11, wherein the locating of the plurality of metering orifices comprises at least one of punching, drilling, shaving, and coining the at least two planar surfaces.

13. The method according to claim 11, wherein the locating of the plurality of metering orifices comprises at least one of stamping and punch forming faceted dimples.

14. The method according to claim 13, wherein the locating comprises punching first, second, third and fourth orifices symmetrical about a first axis extending transverse to the longitudinal axis, the first and fourth orifices being oriented at approximately 10 degrees with respect to a second axis extending transversely to the first axis and the second and third orifices being oriented at approximately 55 degrees with respect to the second axis.

15. The method according to claim 14, wherein the punching comprises orientating the wall of each of the first through fourth orifices at an orifice angle selected from a group consisting of approximately 6 degrees, 8 degrees and 10 degrees.

16. The method according to claim 15, wherein the forming comprises generating a sac volume between the metering disc, seat and the closure member of less than approximately 0.8 cubic-millimeters.
